(19) United States
(12) Patent Application Publication
(10) Pub. No.: US 2005/0238218 A1
(43) Pub. Date: Oct. 27, 2005

(54) Image display method, apparatus and program

(75) Inventor: Keigo Nakamura, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/171,267

(22) Filed: Jul. 1, 2005

(30) Foreign Application Priority Data
Jan. 7, 2004 (JP) 195475/2004

(51) Int. Cl. G06K 9/00

(52) U.S. Cl. 382/128

(57) ABSTRACT

In an image display apparatus, a method for performing an effective comparative image observation is provided for local areas that correspond with each other among a plurality of medical images. When a region of interest is specified on a baseline image displayed on the screen of a display, a corresponding region that corresponds to the region of interest is extracted from each of the comparison images obtained from an image database. Then, reference images, which are images of the corresponding regions and/or an image corresponding to the region of interest generated based on at least one of the images of the corresponding regions, are displayed at a place adjacent to the region of interest of the baseline image on the screen by arranging them side by side or switching them.

### BACKGROUND OF THE INVENTION

1. Field of the Invention

The present invention relates to an image display method, apparatus and program for implementing the method. More specifically, the present invention is directed to an image display method, apparatus and program for implementing the method, which is suitable for use in comparative observation of local areas that correspond with each other among a plurality of medical images.

2. Description of the Related Art

In the medical field, when giving a diagnosis by observing a medical image, such as the x-ray image, tomographic (CT) image, or the like, representing a predetermined area of a patient, a local area of the medical image is compared with a corresponding region on a time-series image obtained by imaging the same area of the same patient in the past, or that of the same modality image representing the same type of region of the other patient to check the probability of a new lesion being developed or to observe the curing passage.

Various types of image display systems are proposed to improve the diagnostic efficiency by facilitating the comparative observation of the local areas on the medical images.

One such image display system is proposed as described, for example, in Japanese Unexamined Patent Publication No. 8 (1996)-076741. In the system, a plurality of images to be compared is displayed simultaneously for comparison on the same screen. When a desired baseline region is set on one of the images, which is defined as the baseline image, displayed on the screen, then a reference region corresponding to the baseline region is set on the other images displayed on the screen, and the baseline and reference regions may be zoomed in as required.

Another type of display system is also proposed as described, for example, in Japanese Unexamined Patent Publication No. 2004-096417. In the system, a local differential image is created through subtractive operation between a local image of the diagnostic region, which is a specified portion of a current image obtained by imaging a current subject, and a local image of a corresponding region that corresponds to the diagnostic region, which is a portion of the current image or past image obtained by imaging the same subject in the past, and the local differential image so obtained is superimposed on top of the diagnostic region or displayed on a separate screen.

In the former system, however, the observable regions are limited to those of the images displayed on the screen. Thus, when a medical observation is conducted by displaying one or more medical images on the screen, and if the observer happens to wish to make a comparative observation between a local area of one of the images displayed on the screen and a corresponding local area of an image not displayed on the screen, reference can not be made to the image not displayed on the screen, otherwise all images to be referenced need to be displayed on the screen. Consequently, where a large number of images are to be referenced, each of the images displayed on the screen becomes too small for the observer.

In the latter system, the reference image displayed on the screen is limited to the differential image. In addition, when the reference image is superimposed on top of the diagnostic region, the observer is not allowed to observe the image of the diagnostic region and the reference image simultaneously, or if the reference image is displayed on a separate screen, the comparison between the two images becomes difficult for the observer since the observer needs to shift the visual axes to a relatively large extent to observe the image of diagnostic region and the reference image.

### SUMMARY OF THE INVENTION

The present invention has been developed in view of the circumstances described above, and it is an object of the present invention to provide an image display method, apparatus and program for implementing the method capable of facilitating an efficient comparative observation among local areas of a plurality of medical images corresponding with each other. The object of the present invention is achieved by providing an image display method, apparatus and program for implementing the method which, in performing a comparative observation among an image of a local area of a predetermined baseline image and images of corresponding regions of other comparison images corresponding to the local area, allows the observer to observe the images of the corresponding regions of comparison images not displayed on the screen, to observe the image of the local area and the images of the corresponding regions simultaneously, and to perform a comparative observation among the images of the local area and corresponding regions without requiring a relatively large shift of visual axes of the observer.

The image display method of the present invention comprises the steps of:
displaying a baseline image on a screen of a display, the baseline image being a medical image of a subject inputted thereto;
obtaining one or more comparison images from a storage device storing multitudes of medical images, each of the comparison images being a medical image of the same type of subject as that of the baseline image;
setting a local area specified on the baseline image displayed on the screen as a region of interest;
extracting a corresponding region that corresponds to the region of interest from each of the comparison images; and
displaying reference images at a place adjacent to the region of interest on the screen, each of the reference images being an image of the corresponding region and/or an image corresponding to the region of interest generated based on at least one of the images of the corresponding regions.

The image display apparatus of the present invention comprises:
an image display means for displaying a baseline image on a screen of a display, the baseline image being a medical image of a subject inputted thereto;
a comparison image obtaining means for obtaining one or more comparison images from a storage device storing multitudes of medical images, each of the comparison images being a medical image of the same type of subject as that of the baseline image;
a region of interest setting means for setting a local area specified on the baseline image displayed on the screen as a region of interest;
a corresponding region extracting means for extracting a corresponding region that corresponds to the region of interest from each of the comparison images; and
a reference image display means for displaying reference images at a place adjacent to the region of interest on the screen, each of the reference images being an image of the corresponding region and/or an image corresponding to the region of interest generated based on at least one of the images of the corresponding regions.

The program of the present invention is a program for causing a computer to perform the functions of:
an image display means for displaying a baseline image on a screen of a display, the baseline image being a medical image of a subject inputted thereto;
a comparison image obtaining means for obtaining one or more comparison images from a storage device storing multitudes of medical images, each of the comparison images being a medical image of the same type of subject as that of the baseline image;
a region of interest setting means for setting a local area specified on the baseline image displayed on the screen as a region of interest;
a corresponding region extracting means for extracting a corresponding region that corresponds to the region of interest from each of the comparison images; and
a reference image display means for displaying reference images at a place adjacent to the region of interest on the screen, each of the reference images being an image of the corresponding region and/or an image corresponding to the region of interest generated based on at least one of the images of the corresponding regions.

The referent of “subject” as used herein means, for example, the chest or breast of a human body, or the like.

The referent of “medical image” as used herein means, for example, a radiation image, tomographic (CT) image, or MRI image.

The referent of “display” as used herein means, for example, a CRT monitor, liquid crystal display (LCD), plasma display panel (PDP), or the like.

The referent of “storage device” as used herein means, for example, an image database, hard disk (HDD), device that reads out image data files from a recording medium, such as a CD-ROM, DVD-ROM, and store them therein.

The referent of “the same type of subject as that of the baseline image” as used herein means the same type of subject comparable to that of the baseline image.

The referent of “displaying reference images at a place adjacent to the region of interest” as used herein means that it does not include the superimposition of the reference image on top of the region of interest.

The “reference image display means” of the present invention may be adapted to display the reference images at a place adjacent to the region of interest by arranging them side by side or switching them.

Further, the “reference image display means” of the present invention may be adapted to display the image of the region of interest and at least one of the reference images by zooming in or out.

The “one or more comparison images” of the present invention may include at least one image selected from the group consisting of time-series, subtraction and energy-subtracted images of the same subject as that of the baseline image, and an artificial image that corresponds to the subject of the baseline image.

The referent of “time-series image” as used herein means an image of the same subject obtained at different time.

The referent of “subtraction image” as used herein means an image that represents the difference between two images obtained by performing so-called the subtractive operation between the two images, in which each pixel value of one of the images is subtracted from the corresponding pixel value of the other image.

The referent of “energy-subtracted image” as used herein means an image generated by performing the subtractive operation between two images which have been obtained by recording two different x-rays having different energy distributions transmitted through the same subject. For example, assuming that the subject is a predetermined region of a human body, the bony tissue portion and soft tissue portion constituting the region have different absorption spectra of radiation. Thus, two images each having different contrast between the bony tissue portion and soft tissue portion may be obtained by imaging the same subject using two different types of x-rays having different ratios of energy components between that which is more liable to be absorbed by the soft tissue portion and that by the bony tissue portion. Thereafter, by performing the subtractive operation between the two images so obtained, an image with the soft tissue portion or bony tissue portion removed or highlighted may be generated.

The referent of “artificial image corresponding to the subject” as used herein means an artificial image substantially identical to the subject in shape and texture, which may be generated, for example, by the method disclosed in Japanese Unexamined Patent Publication No. 2004-041694. In the method, multitudes of different images of the same type of subject are used as the teaching data, and average and characteristic vectors for the shape and texture of that subject type are extracted from the teaching data. Then, a weighted addition (linear sum) is performed on each of the vector groups of the shape and texture using a certain factor, and the texture obtained by the weighted addition is warped on the shape obtained by the weighted addition to create a deformable model. Thus, by adjusting the weighting factors, the model may represent virtually any image of that subject type, which may be used in the present invention.

In the method for generating the artificial image described above, if only the images that represent a normal structure of a certain subject are used as the teaching data, an artificial image that represents the normal structure of the subject may be generated, which is free from the difference arising from different anatomical features when different subjects are used, or the difference arising from the different imaging conditions including the postures of the subject, radiation dosages, or the like. In the present invention, if such an artificial image, which accurately reflects the normal state of the subject structure, is used as the “artificial image corresponding to the subject”, that is, as the reference image for comparison, an efficient comparative observation for checking the probability of a lesion being developed in the suspicious region may be performed.

According to the image display method, apparatus and program for implementing the method, an inputted baseline image, which is a medical image of a subject, is displayed on the screen of a display. Then, one or more comparison images, which are medical images of the same type of subject as that of the subject, are obtained from a storage device storing multitudes of medical images and a local area specified on the baseline image displayed on the screen is set as a region of interest. Thereafter, corresponding regions that correspond to the region of interest are extracted from the comparison images, and reference images, which are images of the corresponding regions and/or images corresponding to the region of interest generated based on at least one of the images of the corresponding regions are displayed at a place adjacent to the region of interest on the screen. This allows the images of the local area which the observer wishes to compare with the image of the region of interest to be displayed at a place adjacent to the region of interest on the screen in concentration without overlapping with the region of interest, regardless of whether or not the comparison images are displayed on the screen. Consequently, in performing a comparative observation, in which an image of the local area of a predetermined baseline image is compared with the images of corresponding regions of the comparison images that correspond to the local area of the baseline image, the observer is allowed to observe the images of the corresponding regions of comparison images not displayed on the screen, to observe the image of the local area of the baseline image and the images of the corresponding regions simultaneously, and to compare the image of the local area of the baseline image with the images of the corresponding regions without shifting the visual axes to a relatively large extent. This allows the observer to perform a comparative observation efficiently for local regions that correspond with each other among a plurality of medical images.

### BRIEF DESCRIPTION OF THE DRAWINGS

FIG. 1 is a schematic block diagram of an image display apparatus according to an embodiment of the present invention, illustrating the configuration thereof.

FIG. 2 is a drawing illustrating a process flow of the image display apparatus shown in FIG. 1.

FIG. 3 is a drawing illustrating an embodiment of the screen display in which reference images are displayed side by side at a place adjacent to the region of interest on the screen of a display.

FIG. 4 is a drawing illustrating another embodiment of the screen display in which reference images are switched and displayed at a place adjacent to the region of interest on the screen of a display.

### DESCRIPTION OF THE PREFERRED EMBODIMENTS

Hereinafter, an embodiment of the present invention will be described with reference to the accompanying drawings.

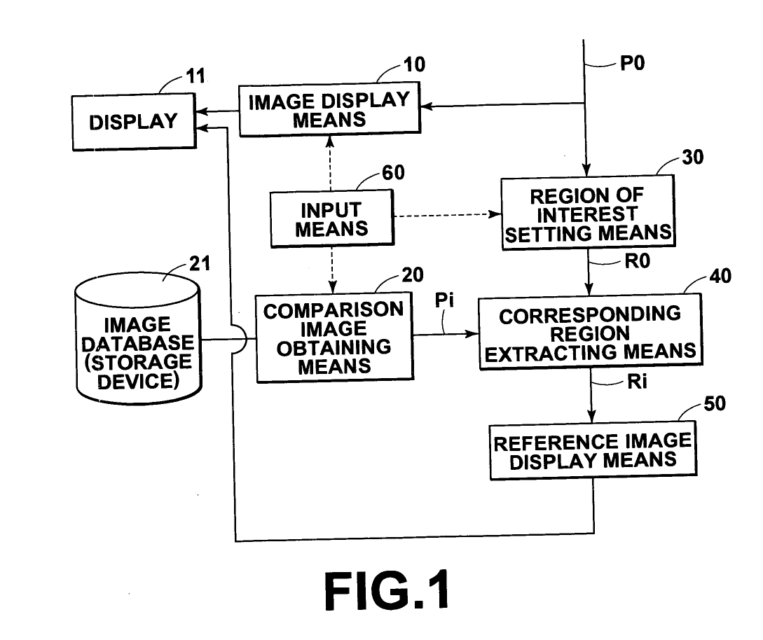

FIG. 1 is a schematic block diagram of an image display apparatus 100 according to an embodiment of the present invention, illustrating the configuration thereof.

The image display apparatus 100 shown in FIG. 1 comprises: an image display means 10 for displaying an inputted baseline image P0, which is a chest x-ray image representing a chest 1a of a patient 1, on a screen 11D of a display 11; comparison image obtaining means 20 for obtaining one or more comparison images Pi (i=1, 2, 3 . . . ), which are medical chest images different from the baseline image P0, from an image database (storage device) 21 storing multitudes of different medical chest images; a region of interest setting means 30 for setting a local area specified on the baseline image P0 displayed on the screen as a region of interest R0; a corresponding region extracting means 40 for extracting a corresponding region Ri that corresponds to the region of interest R0 from each of the comparison images Pi; a reference image display means 50 for displaying reference images Prj (j=1, 2, 3 . . . ), which are images of the corresponding regions Ri and/or an image corresponding to the region of interest generated based on at least one of the images of the corresponding regions, at a place adjacent to the region of interest R0 on the screen 11D; and an input means 60, including a keyboard, mouse, and the like, for inputting various input signals. Here, the referent of “image” in the context of “inputted image”, “obtaining image” and “storing image”, means “image data that represent the image”, which will also apply hereinafter.

Hereinafter, the operation of the image display apparatus 100 will be described.

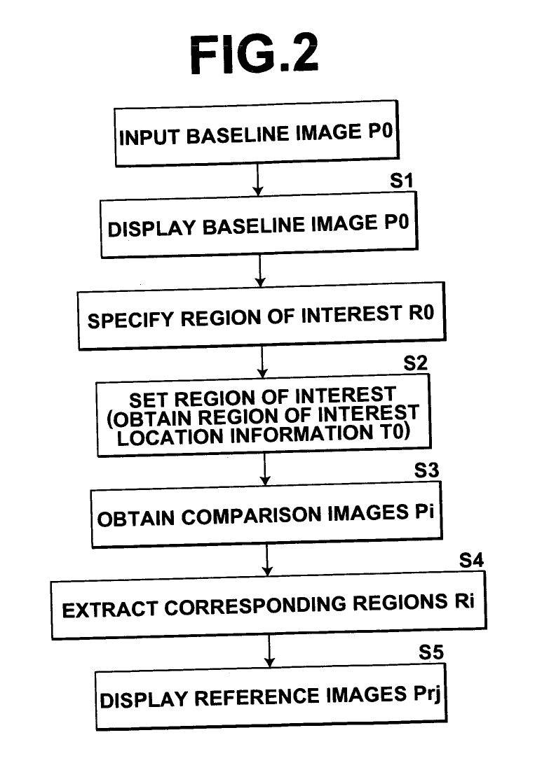

FIG. 2 is a drawing illustrating a schematic process flow of the image display apparatus 100.

When the baseline image P0, which is a chest x-ray image representing a chest 1a of a patient 1 obtained, for example, by the CR system (Computed Radiography System) or the like, is inputted to the image display apparatus 100, it is displayed on the screen 11D of the display 11 through the image display means 10 (step S1).

When the operator specifies a desired local area, for example, a local area of a suspicious lesion on the baseline image P0 which the operator wants to compare with other images, by enclosing it with a frame or the like through the input means 60, the specified local area is set as the region of interest R0 by the region of interest setting means 30 to obtain a region of interest location information T0 which indicates the location of the region of interest R0 (step S2). In this case, information represented by a coordinate system which simply expresses the position that corresponds to each pixel of the baseline image P0 may be used as the region of interest location information T0. In the present embodiment, however, the coordinate system is first normalized based on the anatomical features so that the corresponding region Ri on the comparison image to be compared with the region of interest R0 becomes an appropriate region for making comparison, that is, it becomes an anatomically corresponding structural region. Then, the information represented by the normalized coordinate system is obtained as the region of interest location information T0.

For example, the lung field on a baseline image P0 is identified by a known method to set a baseline region of the lung, which is defined by the area between the uppermost and lowermost edges of the lung field (vertical width) and the area between the innermost and outermost edges of the lung field (horizontal width). Then, a reference point is set at one of the predetermined corner of the reference region to normalize the lung field to a coordinate system with the horizontal and vertical lengths of the baseline region set as value 1 respectively. Thereafter, location information of predetermined positions by which the frame for identifying the region of interest R0 may be defined, such as the location information of both ends of the diagonal line of the frame, on the normalized coordinate system is obtained as the region of interest location information T0.

In the mean time, comparison image obtaining means 20 retrieves one or more medical chest images representing the chest 1a of the same patient 1, such as a time-series image obtained in the past, subtraction image, energy-subtracted image, or artificial image representing the normal chest structures of the patient 1, from the image database 21 as the comparison images Pi (step S3). In the retrieval of the images, all the images deemed to be appropriate as comparison images or some of them are selectively retrieved based on, for example, the information indicating the patient ID, imaged region, type of image and the like, attached to the inputted baseline image P0 or inputted by the operator through the input means 60.

The corresponding region extracting means 40 performs the normalization process, which is identical to that described above, on each comparison image Pi obtained by the comparison image obtaining means 20 based on the anatomical information to obtain the normalized coordinate system, and extracts the location corresponding to the location indicated by each region of interest location information T0 obtained from each normalized coordinate system as the corresponding region Ri (step S4).

Normally, the reference image display means 50 displays each image of each corresponding region Ri as the reference image at a place adjacent to the region of interest R0 on the screen 11D. Here, an image corresponding to the region of interest R0 may be generated based on at least one of the images of the corresponding regions Ri and displayed as the reference image in addition to or instead of the images of the corresponding regions Ri.

For example, the baseline image P0 is first confirmed through the tag information attached thereto whether it is a normal image obtained at a certain time, that is, not a subtraction image, energy-subtracted image, or the like. Then, if it is a normal image, a past time-series image of the chest 1a of the same patient 1 is searched for among the comparison images Pi based on the tag information attached to each comparison image Pi obtained by the comparison image obtaining means 20 or the like. If, a time-series image is detected, an image subtraction process (subtractive operation) is performed between the image Pr0 of the region of interest P0 on the baseline image P0 and an image of the corresponding region extracted by the corresponding region extracting means 40 from the detected time-series image to generate a time-series subtraction image Prs of the local area corresponding to the region of interest R0, which is displayed at a place adjacent to the region of interest R0 on the screen 11D like each of the images Prj of each of the corresponding regions (step S5).

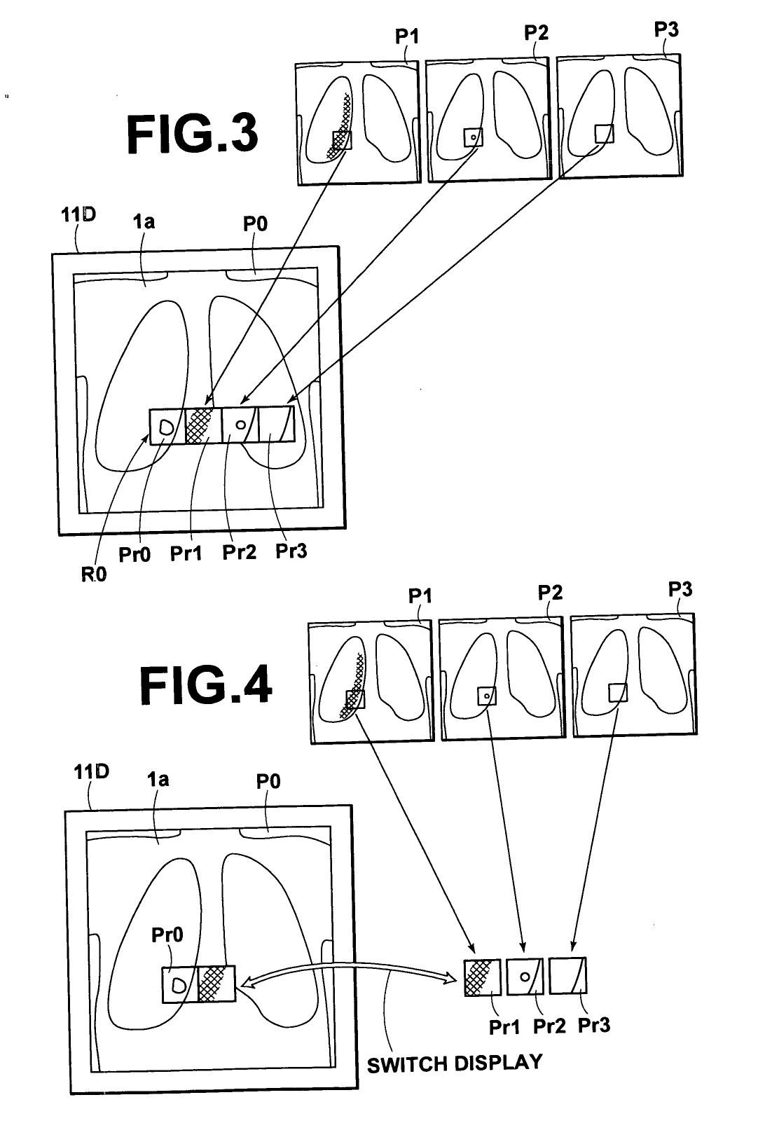

Generally, the reference images may be displayed on the screen 11D in the two different ways. One is to display them side by side (parallel display mode) at a place adjacent to the region of interest R0 as shown in FIG. 3, and the other is to switch and display them (switch display mode) at the place adjacent to the region of interest R0 as shown in FIG. 4. The display mode may be preset or selected based on the display mode selecting information inputted through the input means 60. In addition, the image Pr0 of the region of interest R0 and the reference images Prj may be zoomed in or out wholly or selectively. FIGS. 3 and 4 show the screen displays in which the images Pr1, Pr2 and Pr3, each corresponding to each of the corresponding regions on the comparison images P1, P2 and P3, are displayed in the parallel mode and switch display mode respectively. In the switch display mode, the images may be switched automatically at predetermined time intervals, or they may be switched each time through a certain input signal that indicates the switching.

As has been described above, according to the image display apparatus of the present invention, an inputted baseline image, which is a medical image of a subject, is displayed on a screen of a display. Then, one or more comparison images, which are medical images of the same type of subject as that of the subject, are obtained from a storage device storing multitudes of medical images. Thereafter, a local area specified on the baseline image displayed on the screen is set as a region of interest, and corresponding regions that correspond to the region of interest are extracted from the comparison images. Then, reference images, which are images of the corresponding regions and/or an image corresponding to the region of interest generated based on at least one of the images of the corresponding regions, are displayed at a place adjacent to the region of interest on the screen. This allows the images of the local area which the observer wishes to compare with the image of the region of interest to be displayed at a place adjacent to the region of interest on the screen in concentration without overlapping with the region of interest, regardless of whether or not the comparison images are displayed on the screen. Consequently, in performing a comparative observation, in which an image of the local area of a predetermined baseline image is compared with the images of corresponding regions of the comparison images corresponding to the local area of the baseline image, the observer is allowed to observe the images of the corresponding regions of comparison images not displayed on the screen, to observe the image of the local area of the baseline image and the images of the corresponding regions simultaneously, and to compare the image of the local area of the baseline image with the images of the corresponding regions without shifting the visual axes to a relatively large extent. This allows the observer to perform the comparative observation efficiently for local regions that correspond with other among a plurality of medical images.

Further, the image display apparatus of the present invention has an advantage over the image display apparatus as proposed, for example, in Japanese Unexamined Patent Publication No. 8(1996)-076741, in that it does not require burdensome procedures for switching between the overall observation of a subject and comparative observation of the local area of the subject.

In the present embodiment, the region of interest R0 is determined based on the information inputted by the operator. Alternatively, an abnormal shadow detecting means that automatically detects a candidate of abnormal shadow on a medical image, as disclosed, for example, in Japanese Unexamined Patent Publication Nos. 8(1996)-294479 and 8(1996)-287230, may be used to detect a candidate of abnormal shadow on the baseline image P0, and a predetermined region that includes the candidate may be specified as the region of interest R0.

Further, in the present embodiment, each corresponding region Ri is extracted from each comparison image using a normalized coordinate system normalized according to the anatomical features, in which the region defined by the location corresponding to that of the region of interest R0 in the normalized coordinate system is extracted as the corresponding region Ri. Alternatively, for example, the method disclosed in Japanese Unexamined Patent Publication No. 2004-156970 may be used to identify anatomical structures, such as ribs and the like, on the baseline image and each of the comparison images. Then, the position of the region of interest R0 is obtained, which is defined as a certain relative position with reference to that of the anatomical structure identified on the baseline image, and the region located in the relative position with reference to that of the identical anatomical structure identified on the comparison image is extracted as the corresponding region. Further, the local areas adjacent to the extracted region may be searched for the image which is similar to the image Pr0 of the region of interest R0 using a correlation value that indicates the similarity, and the local area including a similar image may be extracted as the corresponding region Ri.

1. An image display method, comprising the steps of:
displaying a baseline image on a screen of a display, the baseline image being a medical image of a subject inputted thereto;
obtaining one or more comparison images from a storage device storing multitudes of medical images, each of the comparison images being a medical image of the same type of subject as that of the baseline image;
setting a local area specified on the baseline image displayed on the screen as a region of interest;
extracting a corresponding region that corresponds to the region of interest from each of the comparison images; and
displaying reference images at a place adjacent to the region of interest on the screen, each of the reference images being an image of the corresponding region and/or an image corresponding to the region of interest generated based on at least one of the images of the corresponding regions.

2. An image display apparatus, comprising:
an image display means for displaying a baseline image on a screen of a display, the baseline image being a medical image of a subject inputted thereto;
a comparison image obtaining means for obtaining one or more comparison images from a storage device storing multitudes of medical images, each of the comparison images being a medical image of the same type of subject as that of the baseline image;
a region of interest setting means for setting a local area specified on the baseline image displayed on the screen as a region of interest;
a corresponding region extracting means for extracting a corresponding region that corresponds to the region of interest from each of the comparison images; and
a reference image display means for displaying reference images at a place adjacent to the region of interest on the screen, each of the reference images being an image of the corresponding region and/or an image corresponding to the region of interest generated based on at least one of the images of the corresponding regions.

3. The image display apparatus according to claim 2, wherein the reference image display means is adapted to display the reference images at a place adjacent to the region of interest on the screen by arranging the images side by side.

4. The image display apparatus according to claim 2, wherein the reference image display means is adapted to display the reference images at a place adjacent to the region of interest on the screen by switching the images.

5. The image display apparatus according to claim 2, wherein the reference image display means is adapted to display the image of the region of interest and at least one of the reference images by zooming in or out.

6. The image display apparatus according to claim 3, wherein the reference image display means is adapted to display the image of the region of interest and at least one of the reference images by zooming in or out.

7. The image display apparatus according to claim 4, wherein the reference image display means is adapted to display the image of the region of interest and at least one of the reference images by zooming in or out.

8. The image display apparatus according to claim 2, wherein the one or more comparison images include at least one of the images among time-series, subtraction and energy-subtracted images of the same subject as that of the baseline image, and an artificial image that corresponds to the subject of the baseline image.

9. The image display apparatus according to claim 3, wherein the one or more comparison images include at least one of the images among time-series, subtraction and energy-subtracted images of the same subject as that of the baseline image, and an artificial image that corresponds to the subject of the baseline image.

10. The image display apparatus according to claim 4, wherein the one or more comparison images include at least one of the images among time-series, subtraction and energy-subtracted images of the same subject as that of the baseline image, and an artificial image that corresponds to the subject of the baseline image.

11. A program for causing a computer to perform the functions of:
an image display means for displaying a baseline image on a screen of a display, the baseline image being a medical image of a subject inputted thereto;
a comparison image obtaining means for obtaining one or more comparison images from a storage device storing multitudes of medical images, each of the comparison images being a medical image of the same type of subject as that of the baseline image;
a region of interest setting means for setting a local area specified on the baseline image displayed on the screen as a region of interest;
a corresponding region extracting means for extracting a corresponding region that corresponds to the region of interest from each of the comparison images; and
a reference image display means for displaying reference images at a place adjacent to the region of interest on the screen, each of the reference images being an image of the corresponding region and/or an image corresponding to the region of interest generated based on at least one of the images of the corresponding regions.
